(19) United States
(12) Patent Application Publication
(10) Pub. No.: US 2009/0073147 A1
(43) Pub. Date: Mar. 19, 2009

(54) Driving IC for display apparatus, display apparatus and setting data programming method thereof

(75) Inventors: Jong-kon Bae, Seoul (KR); Sang-hun Kim, Seoul (KR)

Correspondence Address: MILLS & ONELLO LLP, ELEVEN BEACON STREET, SUITE 605, BOSTON, MA, 02108, US

(73) Assignee: Samsung Electronics Co., Ltd., Suwon-si (KR)

(21) Appl. No.: 12/156,530

(22) Filed: Jun. 2, 2008

(30) Foreign Application Priority Data
Sep. 13, 2007 (KR) 10-2007-0093261

(51) Int. Cl. G06F 3/038

(52) U.S. Cl. 345/204; 345/559

(57) ABSTRACT

A driving integrated circuit (IC) in which operations of registers and a method of programming setting data are improved, a display apparatus including the same, and the method of programming setting data of the display apparatus are provided. The display apparatus includes a panel displaying images, a driving IC disposed to drive the display apparatus and including a register block temporarily storing externally provided data, and a non-volatile memory storing setting data setting up operating conditions of the display apparatus. The register block includes one or more registers disposed in series, stores the data during a first interval of acquiring the setting data, and shifts and outputs data stored in the registers during a second interval for programming the acquired setting data to the non-volatile memory.

### CROSS-REFERENCE TO RELATED PATENT APPLICATION

This application claims the benefit of Korean Patent Application No. 10-2007-0093261, filed on Sep. 13, 2007, in the Korean Intellectual Property Office, the contents of which are incorporated herein in their entirety by reference.

### BACKGROUND OF THE INVENTION

1. Field of the Invention

The present invention relates to a driving integrated circuit (IC) for display apparatuses, and more particularly, to a driving IC in which operations of registers included in the driving IC are improved, a display apparatus including the same, and a method of programming setting data of the display apparatus.

2. Description of the Related Art

Generally, liquid crystal displays (LCD) are display apparatuses used in laptop computers, computer monitors, etc. Each of the display apparatuses includes a panel displaying images, and the panel includes a plurality of pixels that are formed where a plurality of scanlines carrying gate selecting signals, and a plurality of datalines carrying image data, that is, gray scale data, cross each other.

A driving integrated circuit (IC), driving the display apparatuses including the LCD, may be designed to integrate a scan driving unit driving the scanlines and a source driving unit driving the datalines into a single chip. Also, compact display apparatuses, included in compact personal computers, cellular phones, etc., may include driving ICs on their panel modules to drive the panels.

FIG. 1 is a block diagram of a conventional display apparatus 20.

As shown in FIG. 1, a conventional display apparatus 20 includes a driving IC 21, a panel 22, and a non-volatile memory 23. The display apparatus 20 receives a command CMD, data DATA, and a clock signal CLK via a control device such as a central processing unit (CPU) 10 that is disposed external to the display apparatus 20.

Since display apparatuses such as LCDs have different values for gamma curves, frame frequencies, driving voltages, etc., than each other, the conventional display apparatus 20, including the driving IC 21, is tested to determine an optimal operating condition of the conventional display apparatus 20. To test the conventional display apparatus 20, the panel 22 is operated by using the command CMD and the data DATA input by the CPU without a synchronization, and optimal setting data is acquired based on a result of driving the conventional display apparatus 20. The optimal setting data is stored in the non-volatile memory 23 disposed outside of the driving IC 21. An electrically erasable/programmable read-only memory (EEPROM), which maintains stored data even when the power of the optimal display apparatus 20 is off, may be used as the non-volatile memory 23. When an initialization of the conventional display apparatus 20 is carried out by a reset command, the optimal setting data stored in the non-volatile memory 23 is read, so that operating conditions of the conventional display apparatus 20 are set up.

FIG. 2 is a circuit diagram of a register block included in the driving IC 21. As shown in FIG. 2, the register block may include a plurality of registers, such as flip-flops. Data D[7:0], provided by the CPU 10, are input to each of the registers. As shown in FIG. 2, the registers are disposed in parallel, and the registers receive the data D[7:0] via their inputs, store the data D[7:0] in synchronization with the clock signals CLK, and output the stored data D[7:0]. Data output from the registers are used to drive the panel 22. Optimal setting data is acquired based on a result of driving the display apparatus 20, and is stored in the non-volatile memory 23.

During the storage of the optimal setting data, it is necessary for the CPU 10 to include separate software for programming the optimal setting data to the non-volatile memory 23. That is, as the separate software is executed, the CPU 10 simultaneously provides data, corresponding to the optimal setting data, directly to the non-volatile memory 23 via an interface connecting the CPU 10 and the non-volatile memory 23. Once the optimal setting data is programmed to the non-volatile memory 23, operating conditions of the display apparatus 20 are set up according to the optimal setting data when the display apparatus 20 is initialized.

However, in the cases as described-above, it takes a large effort and time to employ the separate software in the CPU 10 to program the optimal setting data to the non-volatile memory 23.

### SUMMARY OF THE INVENTION

The present invention provides a driving integrated circuit (IC) capable of programming setting data without including separate software in a central processing unit (CPU).

According to one aspect, the present invention is directed to a display device or apparatus including a panel displaying images, a driving IC disposed to drive the panel and having a register block temporarily storing externally provided data such as commands and/or parameters, and a non-volatile memory storing setting data to set up operating conditions of the display apparatus. The register block includes one or more registers disposed in series, stores the data during a first interval acquiring the setting data, and shifts and outputs the data stored in the registers during a second interval programming the acquired setting data to the non-volatile memory.

Data output from the register block in sequence may be programmed to the non-volatile memory during the second interval.

The data stored in the registers may be provided inside the apparatus for driving of the display apparatus during the first interval, and the data stored in the registers may be shifted and may be output via an output of one of the registers to provide the setting data to the non-volatile memory during the second interval.

The register block may further include a first multiplexer unit having one or more multiplexers respectively connected to inputs of the registers.

Each of the multiplexers of the first multiplexer unit may receive the data via a first input of each, may receive an output from a first register via a second input of each, and may provide one of the signals received via the first input and the second input to an input of a second register adjacent to the first register.

The register block may further include a second multiplexer unit including one or more multiplexers respectively connected to clock inputs of the registers.

Each of the multiplexers of the second multiplexer unit may receive a first clock signal used to store the data via a first input of each, may receive a second clock signal used to shift and to output the data stored in the registers via a second input of each, and may provide one of the signals received via the first input and the second input to the clock inputs of the registers.

The driving IC may further receive an enabling signal to control the first multiplexer unit and the second multiplexer unit.

In synchronization with a first state of the enabling signal, each of the multiplexers of the first multiplexer unit may output the data received via the first input, and each of the multiplexers of the second multiplexer unit may output the first clock signal.

In synchronization with a second state of the enabling signal, each of the multiplexers of the first multiplexer unit may output signals provided from a previous register via the second input, and each of the multiplexers of the second multiplexer unit may output the second clock signal.

According to another aspect, the present invention is directed to a driving IC operating a display apparatus including one or more registers electrically connected to an external non-volatile memory and disposed in series to store externally provided data, and one or more first multiplexers respectively connected to inputs of the registers. To program setting data setting up operating conditions of the display apparatus to the non-volatile memory, the data is stored in the registers during a first interval of acquiring the setting data, and the data stored in the registers are shifted and output during a second interval for programming the setting data to the non-volatile memory.

In one embodiment, data, output from the registers in sequence, are programmed to the non-volatile memory.

In one embodiment, each of the first multiplexers: receives the data via a first input; receives an output via a second input; and provides one of the signals received via the first input and the second input to an input of a second register adjacent to the first register.

In one embodiment, the driving IC further comprises one or more second multiplexers respectively connected to clock inputs of the registers. Each of the second multiplexers receives a first clock signal used to store the data via a first input, receives a second clock signal used to shift and to output the data stored in the registers via a second input, and outputs one of the first and second clock signals to the clock inputs of the registers.

In one embodiment, the driving IC receives an enabling signal controlling the first multiplexers and the second multiplexers.

According to another aspect, the present invention is directed to a driving IC operating a display apparatus including one or more registers electrically connected to an external non-volatile memory and disposed in parallel to store externally provided data, and an output control unit interconnected between outputs of the registers and the non-volatile memory, receiving data stored in the registers as setting data for the display apparatus, and outputting the received data to the non-volatile memory in sequence in response to an external output control signal.

In one embodiment, the output control unit is: disabled during a first interval of acquiring the setting data regarding to operating conditions of the display device; and enabled during a second interval of storing the setting data to the non-volatile memory.

According to another aspect, the present invention is directed to a method of programming setting data of a display apparatus, including: receiving data and clock signals from a CPU, storing the data to one or more registers disposed in series, acquiring the setting data setting up operating conditions of the display apparatus by driving the display apparatus using the data stored in the registers, shifting and outputting data which are stored in the registers and correspond to the setting data, and programming the setting data by providing the output data to an external non-volatile memory.

In one embodiment, the each of the registers: receives externally provided data via input in the acquiring of the setting data; and receives data output from a previous register via the input in the shifting and outputting of data.

In one embodiment: the externally provided data and the data output from the previous register are multiplexed; and the externally provided data or the data output from the previous register is provided to the input of the register.

In one embodiment, the method further comprises receiving a first clock signal used to store the data and a second clock signal used to shift and output the data.

In one embodiment: the first clock signal and the second clock signal are multiplexed; and the first clock signal or the second clock signal is provided to clock input of the register.

### BRIEF DESCRIPTION OF THE DRAWINGS

The foregoing and other objects, features and advantages of the invention will be apparent from the more particular description of preferred aspects of the invention, as illustrated in the accompanying drawings in which like reference characters refer to the same parts throughout the different views. The drawings are not necessarily to scale, emphasis instead being placed upon illustrating the principles of the invention.

FIG. 1 is a block diagram of a conventional display apparatus.

FIG. 2 is a circuit diagram of registers included in a driving IC of the conventional display apparatus of FIG. 1.

FIG. 3 is a block diagram of a display apparatus according to an embodiment of the present invention.

FIG. 4 is a circuit diagram illustrating a register block included in a driving integrated circuit (IC), as shown in FIG. 3, and operating in a first interval.

FIG. 5 is a circuit diagram illustrating the register block of FIG. 4 operating in a second interval.

FIG. 6 is a timing diagram illustrating operations of the register block of the driving IC shown in FIGS. 4 and 5.

FIG. 7 is a block diagram of a driving IC according to another embodiment of the present invention.

FIG. 8 is a flow chart illustrating a method of programming setting data according to an embodiment of the present invention.

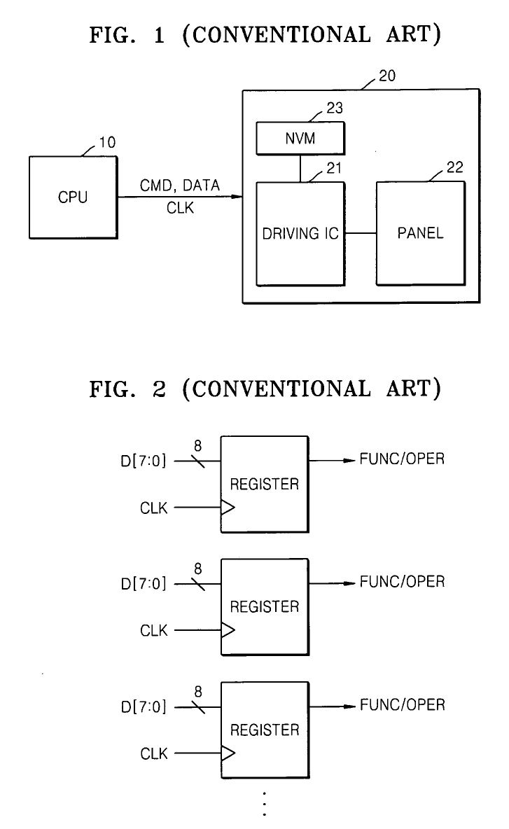

### DETAILED DESCRIPTION OF PREFERRED EMBODIMENTS OF THE INVENTION

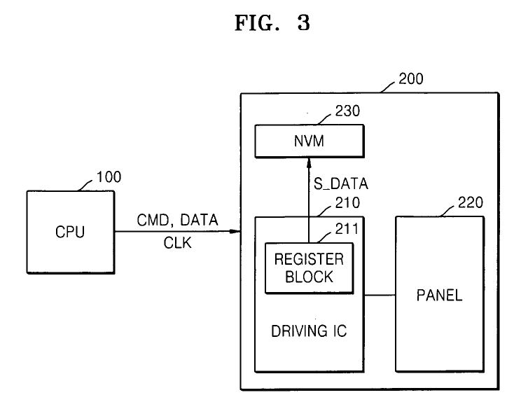

FIG. 3 is a block diagram of a display apparatus 200 according to an embodiment of the present invention. For convenience of description, a central processing unit (CPU) 100, connected to the display apparatus 200, is also shown in FIG. 3. The CPU 100 may be disposed outside the display apparatus 200. As shown in FIG. 3, the display apparatus 200 may include a driving integrated circuit (IC) 210 driving the entire display apparatus 200 by using a command CMD, data DATA, a clock signal CLK, etc., provided by the CPU 100, a panel 220 displaying images under the control of the driving IC 210, and a non-volatile memory (NVM) 230 storing setting data acquired by testing the display apparatus 200. Also, the NVM 230 may be disposed outside of the driving IC 210.

As shown in FIG. 3, the driving IC 210 includes a register block 211 temporarily storing the data DATA that is externally provided. Conventionally, the CPU 100 provides data, corresponding to setting data S_DATA acquired by testing the display apparatus 200, directly to the NVM 230. Thus, as shown in FIG. 3, the register block 211 is electrically connected to the NVM 230, and the setting data S_DATA stored in the register block 211 are provided directly to the NVM 230 without an intervention by the CPU 100 according to the present embodiment of the present invention. The register block 211 includes one or more registers (not shown) that may be disposed in series, and may be operated as shifting registers.

Since display apparatuses, such as liquid crystal displays (LCDs) have optimal values for gamma curves, frame frequencies, driving voltages, etc., that are different from each other, it is necessary to acquire the setting data S_DATA driving the display apparatus 200 in optimal efficiency by testing the display apparatus 200, and store the acquired setting data S_DATA in the NVM 230. When a command such as a reset command is input to the display apparatus 200, the display apparatus 200 is initialized, and operating conditions for the display apparatus 200 are set up by reading the setting data S_DATA stored in the NVM 230 during the initializing operation.

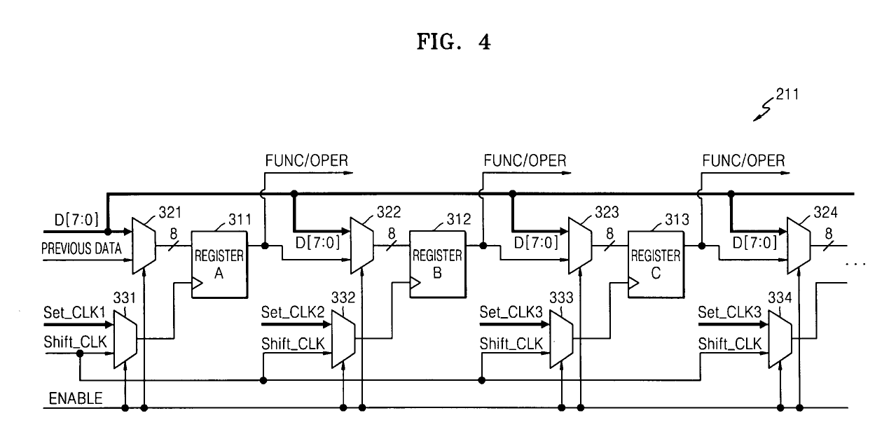

The acquisition of the setting data S_DATA is carried out by driving the display apparatus 200 with the data DATA provided by the CPU 100. The register block 211 temporarily stores the data DATA externally provided in the acquisition of the setting data S_DATA (a first interval). Once the values of the data DATA are determined as the optimal values based on the result of driving the display apparatus 200, the data DATA currently stored in the register block 211 are provided directly to the NVM 230 (a second interval). In case that the registers in the register block 211 are disposed in series, the registers shift and output the data stored in the registers to the NVM 230 in sequence. Operations of the driving IC 210, shown in FIG. 3, will be described hereinafter with reference to FIGS. 4 through 6 in detail.

FIG. 4 is a circuit diagram showing an embodiment of the register block 211 included in the driving IC 210, as shown in FIG. 3, and operating in the first interval. As shown in FIG. 4, the register block 211 may include one or more registers 311, 312, 313, . . . , connected in series, and operating as shifting registers. The register block 211 may further include a first multiplexer unit having one or more multiplexers 321, 322, 323, 324, . . . . The multiplexers 321, 322, 323, 324, . . . , included in the first multiplexer unit may be respectively connected to inputs of the registers 311, 312, 313, . . . . While not shown, if the first register 311 shown in FIG. 4 is the frontmost register of the registers connected to each other in series, the first multiplexer 321, shown in FIG. 4, may be omitted, and data provided by the CPU 100 may be input directly to inputs of the first register 311.

The multiplexers 321, 322, 323, 324, . . . , included in the first multiplexer unit, have two inputs each, multiplex input signals, and output one of the input signals. One of the inputs of each of the multiplexers 321, 322, 323, 324, . . . , is connected to a bus, which transmits the command signals CMD and/or the data DATA provided by the CPU 100. Data D[7:0] provision via the bus to inputs of the multiplexers 321, 322, 323, 324, . . . , is shown in FIG. 4.

The data D[7:0] provided by the CPU 100 and a previous data output from a register disposed before the first register 311 are input to the first multiplexer 321 of which the output is connected to the input of the first register 311. The data D[7:0] provided by the CPU 100 and an output signal from the first register 311 are input to the second multiplexer 322 of which the output is connected to the input of the second register 312. Also, the data D[7:0] provided by the CPU 100 and an output signal from the second register 312 are input to the third multiplexer 323 of which the output is connected to the input of the third register 313.

Also, the register block 211 may further include a second multiplexer unit having one or more multiplexers 331, 332, 333, 334, . . . . The multiplexers 331, 332, 333, 334, . . . , included in the second multiplexer unit may be respectively connected to clock inputs of the registers 311, 312, 313, . . . .

The multiplexers 331, 332, 333, 334, . . . , included in the second multiplexer unit have two inputs each, multiplex input signals, and output one of the input signals. A first clock signal Set_CLK, used to store the data D[7:0] provided by the CPU 100, and a second clock signal Shift_CLK, used to shift and to output the data D[7:0] stored in the registers 321, 322, 323, . . . , may be input to the multiplexers 331, 332, 333, 334, . . . . If the first register 311 is the frontmost register of the registers connected to each other in series and operating as the shifting registers, as described hereinbefore, the multiplexer 331 that is connected to the clock input of the first register 311 may be omitted. In this case, the first clock signal Set_CLK1, used to store the data D[7:0], may be input directly to the clock input of the first register 311.

Also, the display apparatus 200 according to the present embodiment may further include an input (not shown) receiving an enabling signal ENABLE provided by the CPU 100. The enabling signal ENABLE is used to control the first multiplexer unit and the second multiplexer unit, and the enabling signal ENABLE may be in a first state during the acquisition of the setting data in the first interval, and may be in a second state during the shift and output of the data stored in each of the registers 321, 322, 323, . . . , in the second interval.

During the acquisition of the setting data in the first interval, that is, the enabling signal ENABLE is in the first state, the driving IC 210 operates according a signal path as shown in bold lines in FIG. 4. The multiplexers 321, 322, 323, 324, . . . , included in the first multiplexer unit provide the data D[7:0] from the CPU 100 to the inputs of the registers 311, 312, 313, . . . , in response to the enabling signal ENABLE. The multiplexers 331, 332, 333, 334, . . . , included in the second multiplexer unit, multiplex the first clock signals Set_CLK1, Set_CLK2, Set_CLK3, . . . , and provide the first clock signals Set_CLK1, Set_CLK2, Set_CLK3, . . . , to the clock inputs of the registers 311, 312, 313, . . . . Registers 311, 312, 313, . . . , store the data D[7:0] and output the data D[7:0], in synchronization with the first clock signals Set_CLK1, Set_CLK2, Set_CLK3, . . . . The data D[7:0] stored in the registers 311, 312, 313, . . . , are used as data Func/Oper for functions and operations of the display apparatus 200.

Once optimal data values are acquired based on the results of driving the display apparatus 200, the optimal data values, stored in the registers 311, 312, 313, . . . , and used for driving the display apparatus 200, are determined as the setting data S_DATA and are output to the NVM 230.

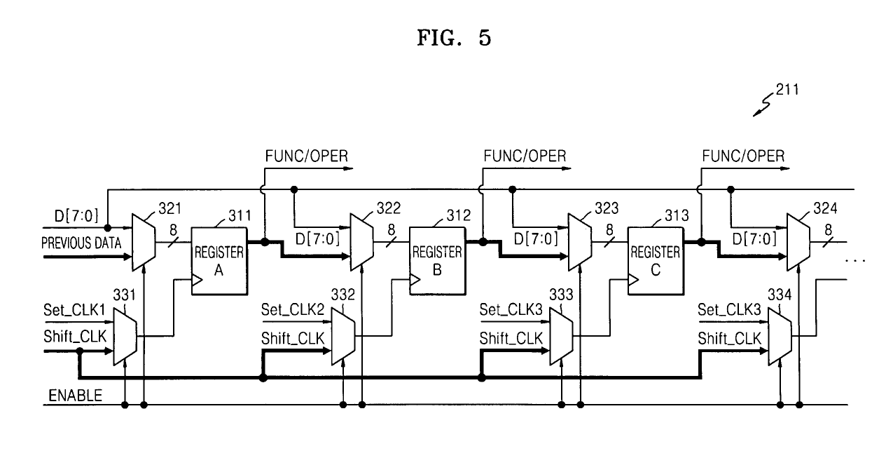

FIG. 5 is a circuit diagram showing the register block 211 operating in the second interval. In the second interval, the enabling signal ENABLE is shifted into the second state, and the multiplexers 321, 322, 323, 324, . . . , included in the first multiplexer unit, output the previous data provided by registers respectively disposed before the multiplexers 321, 322, 323, 324, . . . , in response to the enabling signal ENABLE, as shown in bold lines in FIG. 5. For example, a data output from the register before the first register 311 is input to the input of the first register 311, a data output from the first register 311 is input to the input of the second register 312, and a data output from the second register 312 is input to the input of the third register 313, in response to the enabling signal ENABLE. The registers 311, 312, 313, . . . , store data provided via the inputs of the registers 311, 312, 313, . . . , and output the data, in synchronization with the second clock signal Shift_CLK,

The data stored in the registers 311, 312, 313, . . . , are output thereafter by an output of the rearmost register in the register block 211. The data output in sequence are provided to the NVM 230 as the setting data S_DATA. The setting data S_DATA are programmed according to address signals generated in the driving IC 210. Accordingly, it is not necessary for the CPU 100 to include separate software for programming the setting data S_DATA to the NVM 230. It is also not necessary for the CPU 100 to provide data corresponding to the setting data S_DATA with the NVM 230. The CPU 100 may provide only the clock signals for the operations of the shifting registers to the driving IC 210, and the clock signals used in programming the setting data S_DATA to the NVM 230 may be generated by an oscillator within the driving IC 210.

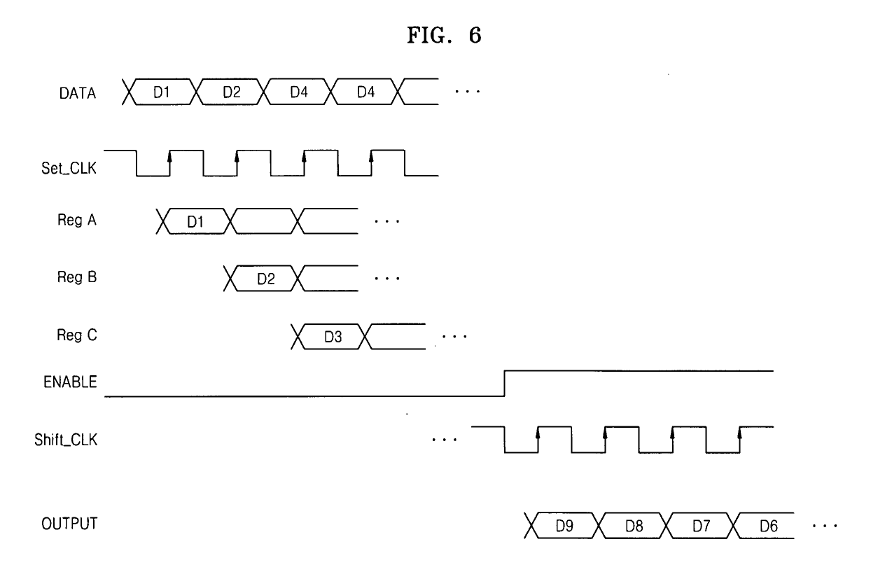

FIG. 6 is a timing diagram of operations of the register block 11 of the driving IC 210, as shown in FIGS. 4 and 5. As shown in FIG. 6, if the enabling signal ENABLE is in the first state, which may be, for example, a low level mode, the registers 311, 312, 313, . . . , respectively store the data D[7:0] provided by the CPU in synchronization with the first clock signals Set_CLK. FIG. 6 illustrates that data D1, D2, D3, . . . , are respectively stored in the first register 311, the second register 312, and the third register 313, in synchronization with the first clock signals Set_CLK. As the enabling signal ENABLE is shifted into the second state, which may be, for example, a high level mode, the registers 311, 312, 313, . . . , operate as the shifting registers in synchronization with the second clock signal Shift_CLK. That is, data respectively stored in the registers 311, 312, 313, . . . , are output in sequence, and are provided to the NVM 230. For example, output signals OUTPUT that are provided by the register block 211 to the NVM 230 are signals output in sequence beginning from a data stored in the last register of the registers 311, 312, 313, . . . .

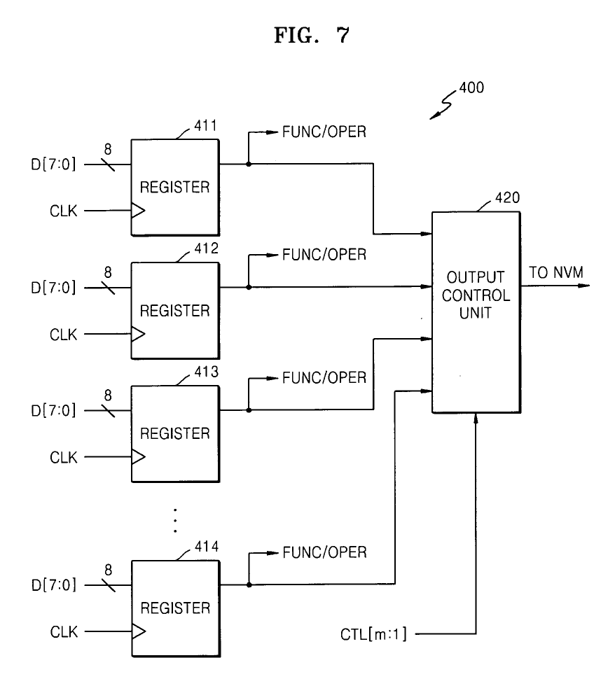

FIG. 7 is a block diagram of a driving IC 400 according to another embodiment of the present invention. As shown in FIG. 7, the driving IC 400 may include one or more registers 411 through 414 to store data D[7:0] externally provided by the CPU 100, such that the registers 411 through 414 may be disposed in parallel as shown in the present embodiment.

The driving IC 400 may further include an output control unit 420 interconnected between the registers 411 through 414 and the NVM 230 disposed outside of the driving IC 400. The output control unit 420 receives outputs from the registers 411 through 414. Also, the output control unit 420 outputs data provided by the registers 411 through 414 to the NVM 230 in sequence in response to a control signal CTL[m:1] that may be a signal provided by the CPU 100.

The output control unit 420 may be disabled in the first interval of acquiring the setting data, and each of the registers 411 through 414 may store the data D[7:0] provided by the CPU 100 in synchronization with the clock signals CLK. The data D[7:0] stored in the registers 411 through 414 are used as the data Func/Oper respectively for functions and operations of the display apparatus 200.

Thus, as the setting data are acquired, the control signal CTL[m:1] is provided to the output control unit 420 in the second interval for programming the setting data to the NVM 230. The output control unit 420 outputs the data D[7:0] stored in the registers 411 through 414 as the setting data to the NVM 230 in response to the control signal CTL[m:1]. The output control unit 420 decodes the control signal CTL[m:1], and outputs data provided by the registers 411 through 414 in sequence according to the result of the decoding. The output control unit 420 interfaces the registers 411 through 414 and the NVM 230, and setting data stored in the registers 411 through 414 are directly provided to the NVM 230 according to the present embodiment. Therefore, it is not necessary for the CPU 100 to include separate software for programming the NVM 230.

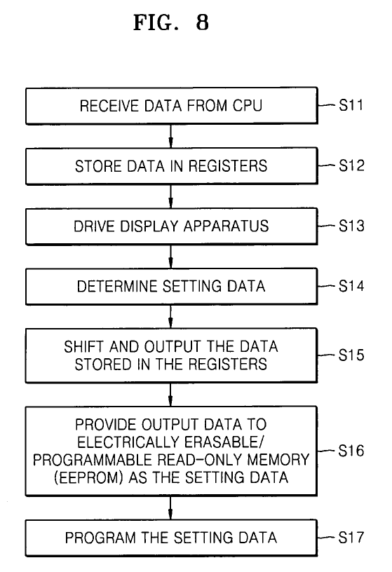

FIG. 8 is a flow chart showing a method of programming setting data according to an embodiment of the present invention. As shown in FIG. 8, data provided by a CPU is received in the acquisition of the setting data to set up operating conditions of a display apparatus (S11). The display apparatus stores the data in registers included in a driving IC in synchronization with a first clock signal provided by the CPU (S12). As described above, the registers may be operated as shifting registers that are connected to each other in series.

The data stored in the registers are used for functions and operations of the display apparatus (S13). Data, driving the display apparatus in optimal efficiency, are acquired based on the results of driving the display apparatus, and the data are determined as the setting data (S14). Once the data stored in the registers are determined as the setting data, the registers provide the setting data directly to a non-volatile memory.

To provide the data directly to the non-volatile memory, the data stored in the registers operating as the shifting registers are shifted and are output (S15). The shift and output of the data may be carried out in synchronization with the second clock signal. In other words, the CPU and the non-volatile memory are not interfaced for the programming operation of the setting data to the NVM. Since the setting data stored in the registers are provided to the non-volatile memory, the CPU does not require separate software for the programming operation of the setting data to the NVM, and may only provide clock signals to the display apparatus.

For example, an output of the last register of the registers connected to each other in series is electrically connected to the external non-volatile memory. First, data stored in the last register is output to the non-volatile memory. As the registers shift data, a data stored in the second last register is output to the non-volatile memory. According to the operations above, the data stored in the registers are output to the non-volatile memory (S16). The data provided to the non-volatile memory are programmed according to address signals generated in the driving IC.

While the present invention has been particularly shown and described with reference to exemplary embodiments thereof, it will be understood by one of ordinary skill in the art that various changes in form and details may be made therein without departing from the spirit and scope of the present invention as defined by the following claims.

What is claimed is:

1. A display apparatus comprising:
a panel displaying images;
a driving IC (integrated circuit) disposed to drive the panel and comprising a register block temporarily storing externally provided data;
a non-volatile memory storing setting data to set up operating conditions of the display apparatus,
wherein the register block.
comprises one or more registers disposed in series;
stores the data during a first interval for acquiring the setting data; and
shifts and outputs the data stored in the registers during a second interval for programming the acquired setting data to the non-volatile memory.

2. The display apparatus of claim 1, wherein data output from the register block in sequence are programmed to the non-volatile memory during the second interval.

3. The display apparatus of claim 2, wherein:
the data stored in the registers are provided inside the apparatus for driving of the display apparatus during the first interval; and
the data stored in the registers are shifted, and output via an output of one of the registers to provide the setting data to the non-volatile memory during the second interval.

4. The display apparatus of claim 1, wherein the register block further comprises a first multiplexer unit having one or more multiplexers respectively connected to inputs of the registers.

5. The display apparatus of claim 4, wherein each of the multiplexers of the first multiplexer unit:
receives the data via a first input;
receives an output from a first register via a second input; and
provides one of the signals received via the first input and the second input to an input of a second register adjacent to the first register.

6. The display apparatus of claim 5, wherein the register block further comprises a second multiplexer unit including one or more multiplexers respectively connected to clock inputs of the registers.

7. The display apparatus of claim 6, wherein each of the multiplexers of the second multiplexer unit:
receives a first clock signal used to store the data via a first input;
receives a second clock signal used to shift and output the data stored in the registers via a second input; and
provides one of the first and second clock signal to the clock inputs of the registers.

8. The display apparatus of claim 7, further receiving an enabling signal to control the first multiplexer unit and the second multiplexer unit.

9. The display apparatus of claim 8, wherein:
each of the multiplexers of the first multiplexer unit outputs the data received via the first input; and
each of the multiplexers of the second multiplexer unit outputs the first clock signal, in synchronization with the first state of the enabling signal.

10. The display apparatus of claim 9, wherein:
each of the multiplexers of the first multiplexer unit outputs signal provided from a previous register via the second input; and
each of the multiplexers of the second multiplexer unit outputs the second clock signal, in synchronization with the second state of the enabling signal.

11. A driving IC operating a display apparatus comprising:
one or more registers electrically connected to an external non-volatile memory, and disposed in series to store externally provided data;
one or more first multiplexers respectively connected to inputs of the registers,
wherein, to program setting data setting up operating conditions of the display apparatus to the non-volatile memory:
the data is stored in the registers during a first interval of acquiring the setting data; and
the data stored in the registers are shifted and output during an second interval for programming the setting data to the non-volatile memory.

12. The driving IC of claim 11, wherein data, output from the registers in sequence, are programmed to the non-volatile memory.

13. The driving IC of claim 11, wherein each of the first multiplexers:
receives the data via a first input;
receives an output via a second input; and
provides one of the signals received via the first input and the second input to an input of a second register adjacent to the first register.

14. The driving IC of claim 13, further comprising one or more second multiplexers respectively connected to clock inputs of the registers, wherein each of the second multiplexers receives a first clock signal used to store the data via a first input, receives a second clock signal used to shift and to output the data stored in the registers via a second input, and outputs one of the first and second clock signals to the clock inputs of the registers.

15. The driving IC of claim 14, further receiving an enabling signal controlling the first multiplexers and the second multiplexers.

16. A driving IC operating a display apparatus comprising:
one or more registers electrically connected to an external non-volatile memory, and disposed in parallel to store externally provided data; and
an output control unit interconnected between outputs of the registers and the non-volatile memory, receiving data stored in the registers as setting data for the display apparatus, and outputting the received data to the non-volatile memory in sequence, in response to an external output control signal.

17. The driving IC of claim 16, wherein the output control unit is:
disabled during a first interval of acquiring the setting data regarding to operating conditions of the display device; and
enabled during a second interval of storing the setting data to the non-volatile memory.

18. A method of programming setting data for a display apparatus comprising:
receiving data and a clock signal from a CPU (central processing unit);
storing the data to one or more registers disposed in series;
acquiring the setting data setting up operating conditions of the display apparatus by driving the display apparatus using the data stored in the registers;
shifting and outputting data which are stored in the registers corresponding to the setting data; and
programming the setting data by providing the output data to an external non-volatile memory.

19. The method of claim 18, wherein the each of the registers:
receives externally provided data via input in the acquiring of the setting data; and
receives data output from a previous register via the input in the shifting and outputting of data.

20. The method of claim 19, wherein:
the externally provided data and the data output from the previous register are multiplexed; and
the externally provided data or the data output from the previous register is provided to the input of the register.

21. The method of claim 18, further comprising receiving a first clock signal used to store the data and a second clock signal used to shift and output the data.

22. The method of claim 21, wherein:
the first clock signal and the second clock signal are multiplexed; and
the first clock signal or the second clock signal is provided to clock input of the register.
